(19) United States
(12) Patent Application Publication
(10) Pub. No.: US 2009/0175551 A1
(43) Pub. Date: Jul. 9, 2009

(54) INTELLIGENT IMAGE ENHANCEMENT

(75) Inventor: Ola THORN, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/969,682

(22) Filed: Jan. 4, 2008

(51) Int. Cl. G06K 9/40

(52) U.S. Cl. 382/254

(57) ABSTRACT

A device receives an image, and measures at least one of location information, direction information, time information, or distance information associated with the device or the image. The device also provides the image and the at least one of location information, direction information, time information, or distance information to an image server, and receives, from the image server, enhanced image information based on the image and the at least one of location information, direction information, time information, or distance information. The device further captures an enhanced image based on the enhanced image information, and stores the enhanced image.

### BACKGROUND

Images may be captured by a variety of consumer electronic devices, such as mobile communication devices (e.g., cell phones, personal digital assistants (PDAs), etc.), cameras (e.g., conventional film cameras or digital cameras), video cameras, etc. Many times, cheaper, low end versions of such devices do not contain optical components (e.g., components contained in more expensive high end devices) that enable the devices to capture high quality images. To capture high quality images, such low end devices need improved optical components and other larger components that make the devices unwieldy (e.g., too thick) and/or too expensive. Enhancing images captured by the low end devices is not possible in real time. Furthermore, the images captured by both high end and low end devices often contain unwanted features (e.g., glare, unwanted objects, blur, etc.) that the devices cannot eliminate.

### SUMMARY

According to one aspect, a method may include receiving an image with a user device, measuring at least one of location information, direction information, time information, or distance information associated with the user device, providing the image and the at least one of location information, direction information, time information, or distance information to an image server, receiving, from the image server, enhanced image information based on the image and the at least one of location information, direction information, time information, or distance information, capturing an enhanced image based on the enhanced image information, and storing the enhanced image.

Additionally, the method may include providing for display an automatic image enhancement option, and receiving selection of the automatic image enhancement option.

Additionally, the method may include providing for display a manual image enhancement option, receiving selection of the manual image enhancement option, providing for display one or more manual image enhancement suggestions, receiving selection of the one or more manual image enhancement suggestions, and receiving, from the image server, the enhanced image information based on the image, the at least one of location information, direction information, time information, or distance information, and selected one or more manual image enhancement suggestions.

Additionally, the method may include providing for display the one or more manual image enhancement suggestions to select a portion of the image, providing for display a suggestion to eliminate the selected image portion, and providing for display a suggestion to enhance the selected image portion.

Additionally, the method may include providing the enhanced image to the image server for storage.

According to another aspect, a method may include receiving an image from a user device, receiving measured information that includes one or more of location information, direction information, time information, or distance information associated with the user device, comparing the image and the measured information with a plurality of images, selecting enhanced image information from the plurality of images based on the image and the measured information, creating an enhanced image based on the enhanced image information, and providing the enhanced image to the user device.

Additionally, the method may include receiving selection of an automatic image enhancement option.

Additionally, the method may include receiving selection of a manual image enhancement option.

Additionally, the method may include receiving selection of one or more manual image enhancement suggestions, comparing the image, the measured information, and the selected one or more manual image enhancement suggestions with the plurality of images, and selecting the enhanced image information from the plurality of images based on the image, the measured information, and the selected one or more manual image enhancement suggestions.

Additionally, the method may include at least one of receiving selection of a portion of the image, receiving selection of a suggestion to eliminate the selected image portion, or receiving selection of a suggestion to enhance the selected image portion.

Additionally, the method may include at least one of automatically selecting enhanced image information that removes lens flare from the image, automatically selecting enhanced image information that improves resolution of the image, automatically selecting enhanced image information that decreases blur in the image, automatically selecting enhanced image information that improves a color balance of the image, or automatically selecting enhanced image information that improves lighting of the image.

According to yet another aspect, a user device may include an image receiving device that receives an image, a monitoring device that measures at least one of location information, direction information, time information, or distance information associated with the image or the user device, and processing logic configured to provide the image and the at least one of location information, direction information, time information, or distance information to an image server, receive, from the image server, enhanced image information based on the image and the at least one of location information, direction information, time information, or distance information, capture an enhanced image based on the enhanced image information, and store the enhanced image.

Additionally, the monitoring device may include at least one of a global positioning system (GPS) receiver, an accelerometer, a gyroscope, a compass, a GPS-based clock, a proximity sensor, a laser distance sensor, a distance sensor using echo location with high frequency sound waves, or an infrared distance sensor.

Additionally, the enhanced image may include a composite image that includes one or more original portions of the image and one or more portions of the image that have been replaced, enhanced, or corrected based on the enhanced image information.

Additionally, the processing logic may be further configured to provide for display an automatic image enhancement option, and receive selection of the automatic image enhancement option.

Additionally, the processing logic may be further configured to provide for display a manual image enhancement option, receive selection of the manual image enhancement option, provide for display one or more manual image enhancement suggestions, receive selection of the one or more manual image enhancement suggestions, and receive, from the image server, the enhanced image information based on the image, the at least one of location information, direction information, time information, or distance information, and the selected one or more manual image enhancement suggestions.

Additionally, the processing logic may be further configured to provide for display a suggestion to select a portion of the image, provide for display a suggestion to eliminate the selected image portion, and provide for display a suggestion to enhance the selected image portion.

Additionally, the processing logic may be further configured to provide the enhanced image to the image server for storage.

Additionally, the user device may include at least one of a mobile communication device, a laptop, a personal computer, a camera, a video camera, binoculars with a camera, or a telescope with a camera.

According to a further aspect, a system may include one or more devices configured to receive an image from a user device, receive measured information that includes one or more of location information, direction information, time information, or distance information associated with the image or the user device, receive selection of an automatic image enhancement option or a manual image enhancement option, automatically compare the image and the measured information with a plurality of images when the automatic image enhancement option is selected, automatically select enhanced image information from the plurality of images based on the image and the measured information when the automatic image enhancement option is selected, receive selection of one or more manual image enhancement suggestions when the manual image enhancement option is selected, compare the image, the measured information, and the selected one or more manual image enhancement suggestions with the plurality of images when the manual image enhancement option is selected, select the enhanced image information from the plurality of images based on the image, the measured information, and the selected one or more manual image enhancement suggestions when the manual image enhancement option is selected, create an enhanced image based on the enhanced image information, and provide the enhanced image to the user device for display.

According to still another aspect, a system may include means for receiving an image from a user device, means for receiving measured information that includes one or more of location information, direction information, time information, or distance information associated with the user device, means for comparing the image and the measured information with a plurality of images, means for selecting enhanced image information from the plurality of images based on the image and the measured information, means for creating an enhanced image based on the enhanced image information, and means for providing the enhanced image to the user device for display.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIG. 1 is an exemplary diagram illustrating a configuration according to concepts described herein;

FIG. 2 depicts an exemplary diagram of a user device illustrated in FIG. 1;

FIG. 3 illustrates a diagram of exemplary components of the user device depicted in FIGS. 1 and 2;

FIG. 4 depicts a diagram of exemplary monitoring devices of the user device illustrated in FIGS. 1 and 2;

FIGS. 5A and 5B illustrate diagrams of exemplary components of an image server depicted in FIG. 1;

FIGS. 6-9 illustrate exemplary user interfaces capable of being provided by the user device depicted in FIGS. 1 and 2;

FIGS. 10A-10C depict flow charts of an exemplary process for intelligently enhancing an image according to implementations described herein; and

FIGS. 11-13 depict flow charts of another exemplary process for intelligently enhancing an image according to implementations described herein.

### DETAILED DESCRIPTION

The following detailed description refers to the accompanying drawings. The same reference numbers in different drawings may identify the same or similar elements. Also, the following detailed description does not limit the invention.

### Overview

Implementations described herein may provide systems and methods that intelligently enhance images captured by a user device in real time or near real time. For example, in one implementation, a user device may receive an image (e.g., via a viewfinder) and/or measured information associated with the user device and/or received image (e.g., one or more of location information, direction information, time information, and/or distance information), and may provide the received image and/or the measured information to an image server. The image server may compare the received image and the measured information with a plurality of images, and may intelligently select enhanced image information based on the received image and/or the measured information. The user device may receive the enhanced image information from the image server, may provide for display of an enhanced image based on the enhanced image information, and may permit a user to capture and/or store the enhanced image.

### Exemplary Configuration

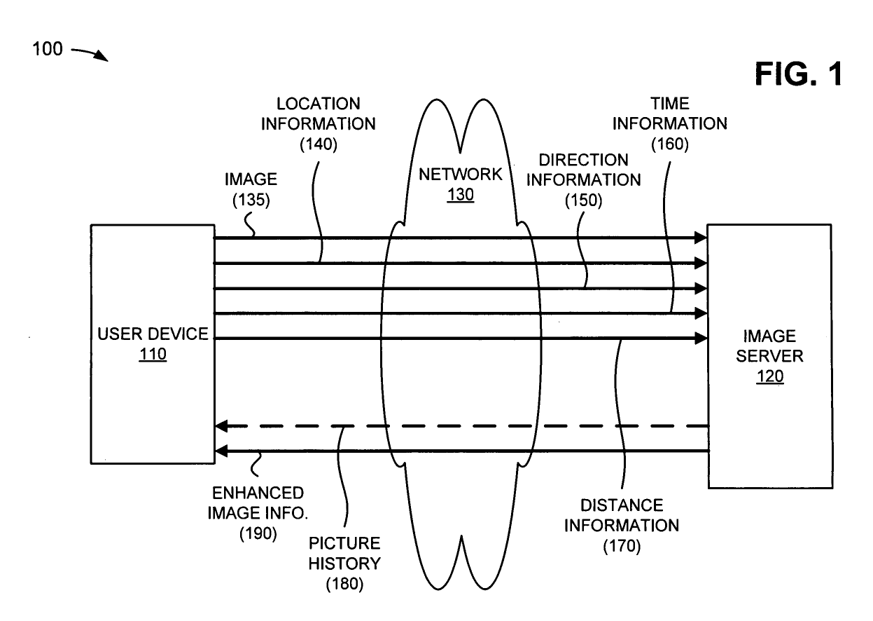

FIG. 1 is an exemplary diagram illustrating a configuration 100 according to concepts described herein. As illustrated, configuration 100 may include a user device 110 and an image server 120 interconnected by a network 130. User device 110 and/or image server 120 may connect to network 130 via wired and/or wireless connections. A single user device, a single image server, and a single network have been illustrated in FIG. 1 for simplicity. In practice, there may be more or less user devices, image servers, and/or networks. Also, in some instances, one or more of user device 110 and/or image server 120 may perform one or more functions described as being performed by another one or more of user device 110 and/or image server 120.

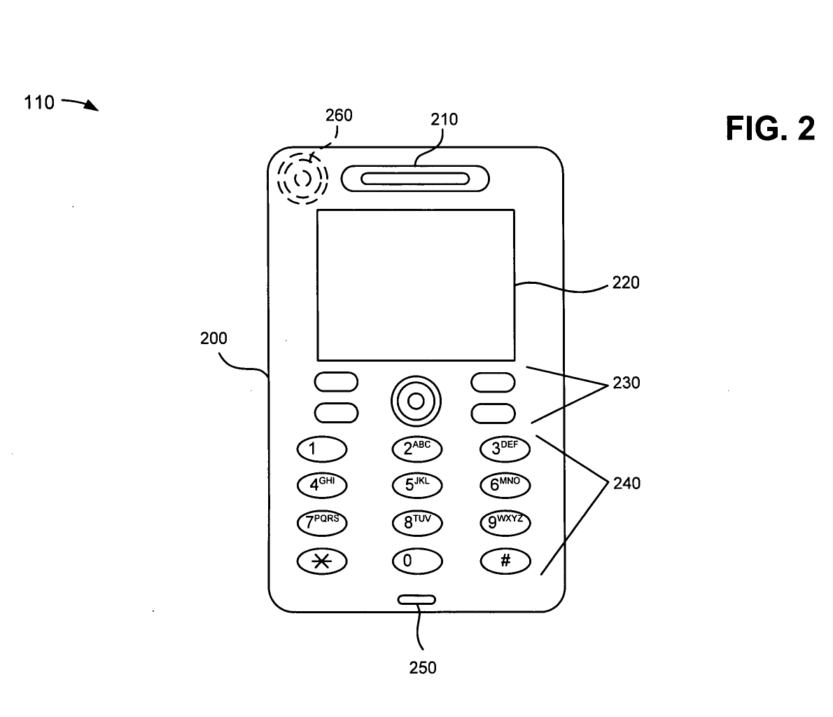

User device 110 may include any device capable of receiving and/or capturing an image (e.g., of a person, place, or thing). For example, user device 110 may include a mobile communication device (e.g., a radiotelephone, a personal communications system (PCS) terminal that may combine a cellular radiotelephone with data processing, a facsimile, and data communications capabilities, a personal digital assistant (PDA) that can include a radiotelephone, pager, Internet/intranet access, web browser, organizer, camera, a Doppler receiver, and/or global positioning system (GPS) receiver, a GPS device, a telephone, a cellular phone, etc.); a laptop; a personal computer; a printer; a facsimile machine; a pager; a camera (e.g., a conventional film camera or a digital camera); a video camera (e.g., a camcorder); a calculator; binoculars with a camera function; a telescope with a camera function; a gaming unit; any other device capable of utilizing a camera; a thread or process running on one of these devices; and/or an object executable by one of these devices. Further details of user device 110 are provided below in connection with FIGS. 2-4.

As used herein, a “camera” may include a device that may receive, capture, and store images and/or video. For example, a digital camera may be an electronic device that may capture and store images and/or video electronically instead of using photographic film. A digital camera may be multifunctional, with some devices capable of recording sound and/or video, as well as images.

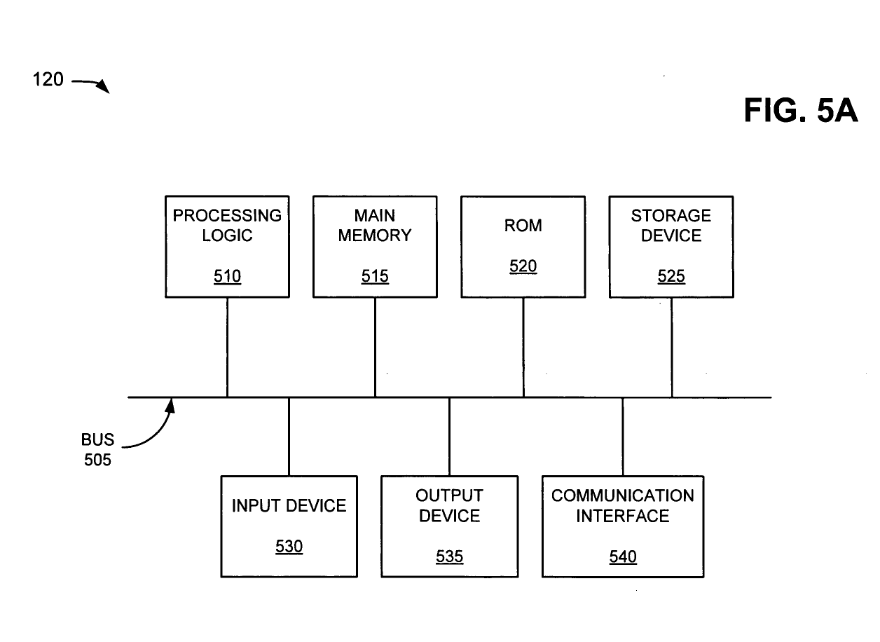

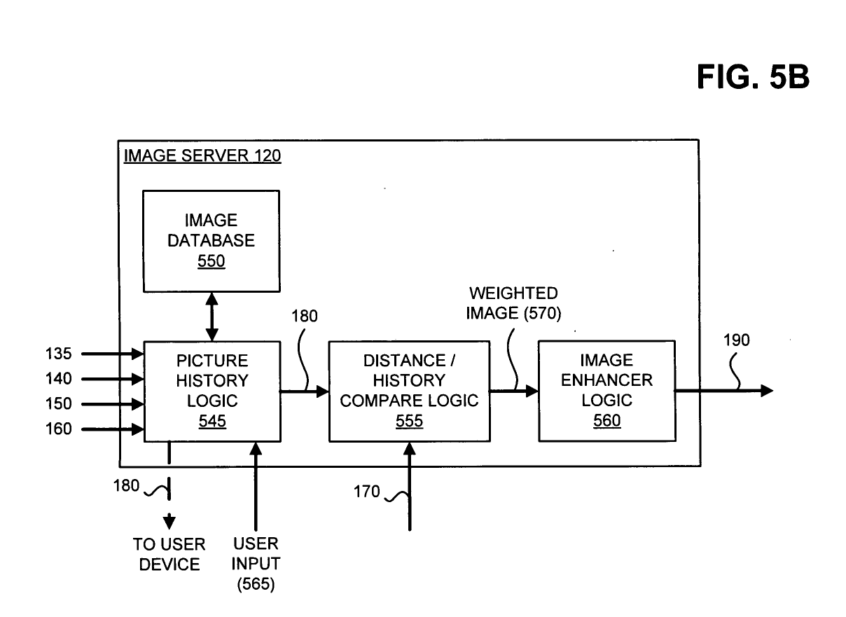

Image server 120 may include one or more server entities, or other types of computation or communication devices, that gather, process, and/or provide information in a manner described herein. In one implementation, image server 120 may receive an image to be captured by user device 110, may intelligently enhance the image, and may provide the enhanced image to user device 110. Further details of image server 120 are provided below in connection with FIGS. 5A and 5B.

Network 130 may include a local area network (LAN), a wide area network (WAN), a metropolitan area network (MAN), an intranet, the Internet, a Public Land Mobile Network (PLMN), a telephone network, such as the Public Switched Telephone Network (PSTN) or a cellular telephone network, or a combination of networks.

As further shown in FIG. 1, user device 110 may receive an image 135 (e.g., a still image and/or video) to be captured, and may determine location information 140, direction information 150, time information 160, and/or distance information 170. User device 110 may provide image 135, location information 140, direction information 150, time information 160, and/or distance information 170 to image server 120. Image 135 may include an image (e.g., displayed on a display screen/viewfinder of user device 110) of any object (e.g., a person, place, or thing). Location information 140 may include positional (e.g., latitude, longitude, etc.) information associated with user device 110 and/or the object included in image 135. Direction information 150 may include orientation (e.g., tilted, turned, pointing to the north, south, east, west, etc.) information associated with user device 110. Time information 160 may include a time (e.g., day time, night time, a specific time of day, etc.) when image 135 is received by user device 110. Distance information 170 may include a distance (e.g., in feet, meters, etc.) that an object represented by image 135 is separated from user device 110.

Image server 120 may receive image 135, location information 140, direction information 150, time information 160, and/or distance information 170, and may compare image 135 with one or more enhanced images of a picture history 180 (e.g., high resolution images, high quality images, etc.) based on location information 140, direction information 150, time information 160, and/or distance information 170. In one implementation, for example, image server 120 may compare data associated with image 135 (e.g., location information 140, direction information 150, time information 160, and/or distance information 170) with data associated with picture history 180 (e.g., aperture, white balancing, color correction, need for flash, etc. information), and may generate enhanced image information 190. Image server 120 may optionally provide picture history 180 (e.g., one or more enhanced images), and may provide enhanced image information 190 (e.g., correction of lens flare, removal of unwanted objects in image, improvement of image resolution, color, and/or lighting, removal of image blur, etc.) to user device 110. In one implementation, enhanced image information 190 may include a composite image that includes one or more original portions of image 135 and one or more portions of image 135 that have been replaced, enhanced, corrected, etc., by image server 120.

User device 110 may receive enhanced image information 190 from image server 120, and may display (e.g., in a viewfinder/display of user device 110) an enhanced image (e.g., the composite image) based on enhanced image information 190. User device 110 may permit a user to capture and/or store the enhanced image.

Although FIG. 1 shows exemplary elements of configuration 100, in other implementations, configuration 100 may contain fewer, different, or additional elements than depicted in FIG. 1.

### Exemplary User Device Configuration

FIG. 2 is an exemplary diagram of user device 110. As illustrated, user device 110 may include a housing 200, a speaker 210, a display 220, control buttons 230, a keypad 240, a microphone 250, and/or a camera 260. Housing 200 may protect the components of user device 110 from outside elements. Speaker 210 may provide audible information to a user of user device 110.

Display 220 may provide visual information to the user. For example, display 220 may display text input into user device 110, text, images, video, and/or graphics received from another device, and/or information regarding incoming or outgoing calls or text messages, emails, media, games, phone books, address books, the current time, etc. In one exemplary implementation, display 220 may act as a viewfinder that may aid user device 110 in capturing and/or storing videos and/or images. Control buttons 230 may permit the user to interact with user device 110 to cause user device 110 to perform one or more operations. For example, control buttons 230 may be used to cause user device 110 to transmit information. Keypad 240 may include a standard telephone keypad. Microphone 250 may receive audible information from the user. Camera 260 may be provided on a front or back side of user device 110, and may enable user device 110 to capture and/or store video and/or images (e.g., pictures).

Although FIG. 2 shows exemplary components of user device 110, in other implementations, user device 110 may contain fewer, different, or additional components than depicted in FIG. 2. In still other implementations, one or more components of user device 110 may perform one or more other tasks described as being performed by one or more other components of user device 110.

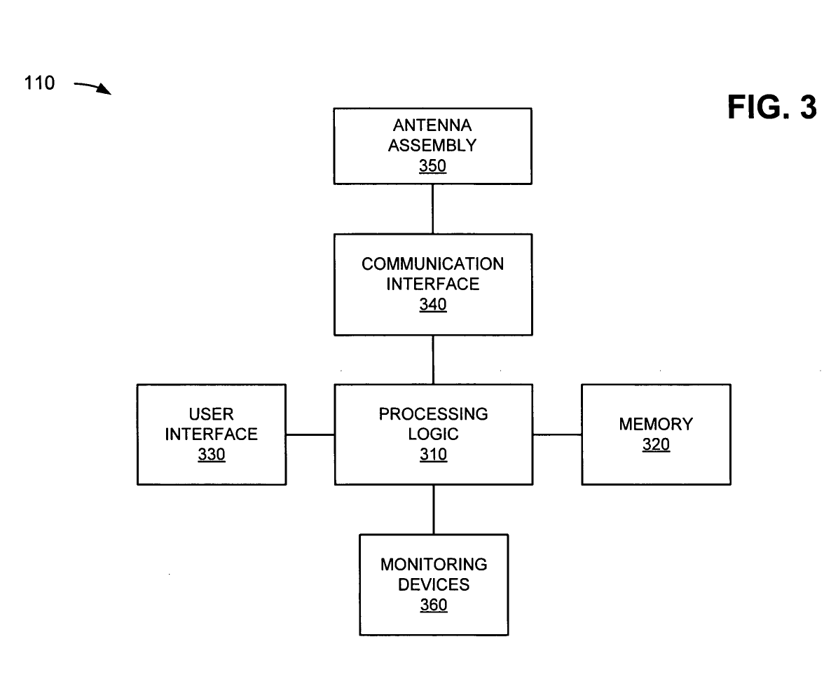

FIG. 3 is a diagram of exemplary components of user device 110. As illustrated, user device 110 may include processing logic 310, memory 320, a user interface 330, a communication interface 340, an antenna assembly 350, and/or one or more monitoring devices 360.

Processing logic 310 may include a processor, a microprocessor, an application specific integrated circuit (ASIC), a field programmable gate array (FPGA), or the like. Processing logic 310 may control operation of user device 110 and its components. In one implementation, processing logic 310 may control operation of components of user device 110 in a manner described herein.

Memory 320 may include a random access memory (RAM), a read-only memory (ROM), and/or another type of memory to store data and instructions that may be used by processing logic 310.

User interface 330 may include mechanisms for inputting information to user device 110 and/or for outputting information from user device 110. Examples of input and output mechanisms might include buttons (e.g., control buttons 230, keys of keypad 240, a joystick, etc.) or a touch screen interface to permit data and control commands to be input into user device 110; a speaker (e.g., speaker 210) to receive electrical signals and output audio signals; a microphone (e.g., microphone 250) to receive audio signals and output electrical signals; a display (e.g., display 220) to output visual information (e.g., text input into user device 110); a vibrator to cause user device 110 to vibrate; and/or a camera (e.g., camera 260) to receive video and/or images.

Communication interface 340 may include, for example, a transmitter that may convert baseband signals from processing logic 310 to radio frequency (RF) signals and/or a receiver that may convert RF signals to baseband signals. Alternatively, communication interface 340 may include a transceiver to perform functions of both a transmitter and a receiver. Communication interface 340 may connect to antenna assembly 350 for transmission and/or reception of the RF signals.

Antenna assembly 350 may include one or more antennas to transmit and/or receive RF signals over the air. Antenna assembly 350 may, for example, receive RF signals from communication interface 340 and transmit them over the air, and receive RF signals over the air and provide them to communication interface 340. In one implementation, for example, communication interface 340 may communicate with a network and/or devices connected to a network.

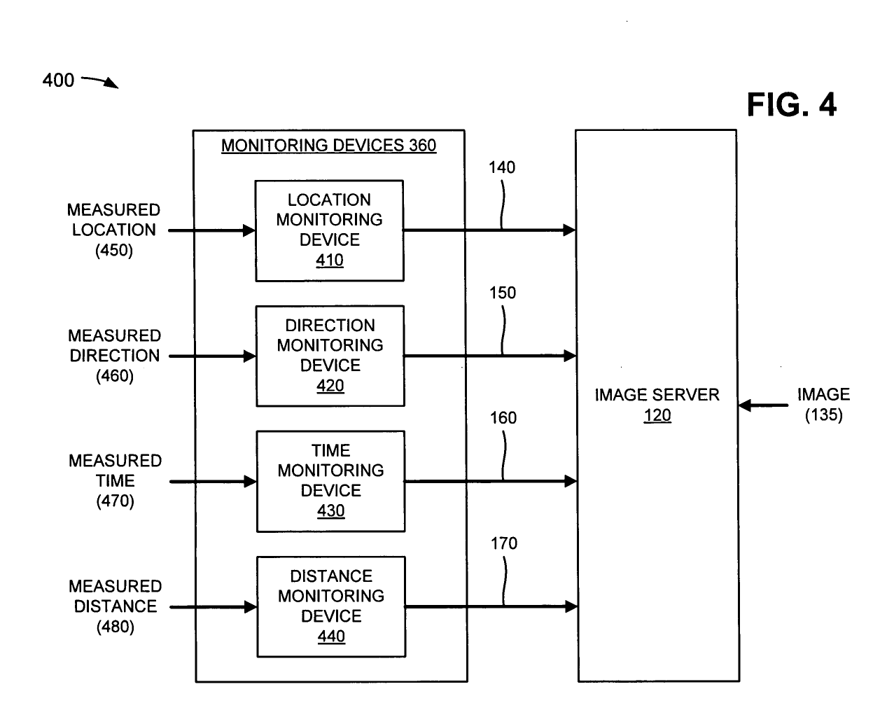

Monitoring devices 360 may include any device capable of monitoring conditions associated with an object (e.g., a person, place, or thing) whose image is to be captured by user device 110. For example, in one implementation, monitoring devices 360 may include a location monitoring device (e.g., a GPS device, etc.), a direction monitoring device (e.g., an accelerometer, a gyroscope, etc.), a time monitoring device, and/or a distance monitoring device (e.g., a proximity sensor, a laser distance sensor, etc.). Further details of monitoring devices 360 are provided below in connection with FIG. 4.

As will be described in detail below, user device 110 may perform certain operations described herein in response to processing logic 310 executing software instructions of an application contained in a computer-readable medium, such as memory 320. A computer-readable medium may be defined as a physical or logical memory device. The software instructions may be read into memory 320 from another computer-readable medium or from another device via communication interface 340. The software instructions contained in memory 320 may cause processing logic 310 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of user device 110, in other implementations, user device 110 may contain fewer, different, or additional components than depicted in FIG. 3. In still other implementations, one or more components of user device 110 depicted in FIG. 3 may perform one or more other tasks described as being performed by one or more other components of user device 110 depicted in FIG. 3.

### Exemplary Monitoring Devices of User Device

FIG. 4 is an exemplary diagram 400 of monitoring devices 360 of user device 110. As illustrated, monitoring devices 360 may include a location monitoring device 410, a direction monitoring device 420, a time monitoring device 430, and/or a distance monitoring device 440.

Location monitoring device 410 may include any device capable of measuring a location of user device 110 and/or an object (e.g., a person, place, or thing) whose image is to be captured by user device 110. For example, in one implementation, location monitoring device 410 may include a GPS device and/or other location sensors capable of measuring the location of user device 110. In other implementations, location monitoring device 410 may include other components of user device 110 that are capable of measuring location, such as processing logic 310. As further shown in FIG. 4, location monitoring device 410 may receive a measured location 450 (e.g., latitude and longitude coordinates associated with user device 110), and may provide location information 140, based on measured location 450, to image server 120.

Direction monitoring device 420 may include any device capable of measuring an orientation (e.g., tilted, turned, pointing to the north, south, east, west, etc.) of user device 110. For example, in one implementation, direction monitoring device 420 may include an accelerometer, a gyroscope, a compass, and/or other direction sensors capable of measuring the orientation of user device 110. In other implementations, direction monitoring device 420 may include other components of user device 110 that are capable of measuring direction, such as processing logic 310. As further shown in FIG. 4, direction monitoring device 420 may receive a measured direction 460 (e.g., tilted, turned, pointing to the north, south, east, west, etc.) associated with user device 110, and may provide direction information 150, based on measured direction 460, to image server 120.

Time monitoring device 430 may include any device capable of measuring a time (e.g., day time, night time, a specific time of day, etc.) when image 135 is received by user device 110. For example, in one implementation, time monitoring device 430 may include a GPS-based clock, and/or other time sensors capable of measuring the time when image 135 is received by user device 110. In other implementations, time monitoring device 430 may include other components of user device 110 that are capable of measuring time, such as processing logic 310. As further shown in FIG. 4, time monitoring device 430 may receive a measured time 470 (e.g., when image 135 is received by user device 110), and may provide time information 160, based on measured time 470, to image server 120.

Distance monitoring device 440 may include any device capable of measuring a distance between user device 110 and an object (e.g., a person, place, or thing) whose image is to be captured by user device 110. For example, in one implementation, distance monitoring device 440 may include a proximity sensor, a laser distance sensor, a distance sensor using echo location with high frequency sound waves, an infrared distance sensor, other distance sensors capable of measuring the distance between user device 110 and the object, etc. In other implementations, distance monitoring device 440 may include other components of user device 110 that are capable of measuring distance, such as processing logic 310. As further shown in FIG. 4, distance monitoring device 440 may receive a measured distance 480 (e.g., away from the object whose image is to be captured by user device 110), and may provide distance information 170, based on measured distance 480, to image server 120. In one example, distance monitoring device 440 may include a GPS device that measures distance between user device and the object (e.g., via GPS coordinates), or a device (e.g., processing logic 310) that compares a video feed of the object to stored images of the object and takes into account differences between lenses in terms of quality and/or representation of distance.

In addition to location information 140, direction information 150, time information 160, and/or distance information 170, image server 120 may also receive image 135 from user device 110.

Although FIG. 4 shows exemplary components of monitoring devices 360, in other implementations, monitoring devices 360 may contain fewer, different, or additional components than depicted in FIG. 4. In still other implementations, one or more components of monitoring devices 360 may perform one or more other tasks described as being performed by one or more other components of monitoring devices 360.

### Exemplary Image Server Configurations

FIG. 5A is a diagram of exemplary components of image server 120. As illustrated, image server 120 may include a bus 505, processing logic 510, a main memory 515, a read-only memory (ROM) 520, a storage device 525, an input device 530, an output device 535, and/or a communication interface 540. Bus 505 may include a path that permits communication among the components of image server 120.

Processing logic 510 may include a processor, microprocessor, a field programmable gate array (FPGA), an application specific integrated circuit (ASIC), or other type of processing logic that may interpret and execute instructions. Main memory 515 may include a random access memory (RAM) or another type of dynamic storage device that may store information and instructions for execution by processing logic 5 10. ROM 520 may include a ROM device or another type of static storage device that may store static information and/or instructions for use by processing logic 510. Storage device 525 may include a magnetic and/or optical recording medium and its corresponding drive.

Input device 530 may include a mechanism that permits an operator to input information to image server 120, such as a keyboard, a mouse, a pen, a microphone, voice recognition and/or biometric mechanisms, etc. Output device 535 may include a mechanism that outputs information to the operator, including a display, a printer, a speaker, etc. Communication interface 540 may include any transceiver-like mechanism that enables image server 120 to communicate with other devices and/or systems. For example, communication interface 540 may include mechanisms for communicating with another device or system via a network, such as network 130.

As described herein, image server 120 may perform certain operations in response to processing logic 510 executing software instructions contained in a computer-readable medium, such as main memory 515. A computer-readable medium may be defined as a physical or logical memory device. The software instructions may be read into main memory 515 from another computer-readable medium, such as storage device 525, or from another device via communication interface 540. The software instructions contained in main memory 515 may cause processing logic 510 to perform processes described herein. Alternatively, hardwired circuitry may be used in place of or in combination with software instructions to implement processes described herein. Thus, implementations described herein are not limited to any specific combination of hardware circuitry and software.

Although FIG. 5A shows exemplary components of image server 120, in other implementations, image server 120 may contain fewer, different, or additional components than depicted in FIG. 5A. In still other implementations, one or more components of image server 120 may perform one or more other tasks described as being performed by one or more other components of image server 120.

FIG. 5B is another diagram of exemplary components of image server 120. As illustrated, image server 120 may include picture history logic 545, an image database 550, distance/history compare logic 555, and image enhancer logic 560. In one implementation, picture history logic 545, distance/history compare logic 555, and/or image enhancer logic 560 may be included in processing logic 510 of image server 120, and image database 550 may be provided in a storage medium (e.g., main memory 515, ROM 520, and/or storage device 525) of image server 120. In other implementations, picture history logic 545, distance/history compare logic 555, and/or image enhancer logic 560 may be separate from processing logic 510 of image server 120, and/or image database 550 may be provided in a device separate from but accessible by image server 120.

Picture history logic 545 may include any hardware and/or software based logic that enables image server 120 to determine picture history 180. In one implementation, picture history logic 545 may receive image 135, location information 140, direction information 150, and/or time information 160 from user device 110, and may compare image 135 with one or more images provided in image database 550 based on the received information. For example, picture history logic 545 may determine if any of the one or more images contained in image database 550 had been captured at a location provided by location information 140, in a direction provided by direction information 150, and/or at a time of day provided in time information 160. Picture history logic 545 may output any images of image database 550 matching the location, direction, and time criteria as picture history 180 (e.g., to user device 110 (optionally) and/or to distance/history compare logic 555). Picture history 180 may be quickly and easily determined by picture history logic 545, without significant data processing, because of location information 140, direction information 150, and/or time information 160. Picture history logic 545 may also receive a user input 565 (e.g., selected image portion(s), image portion(s) to eliminate and/or enhance, etc.), and may determine and output picture history 180 based on user input 565.

Image database 550 may include may include one or more databases containing high resolution images that may be received by image server 120 (e.g., from another device) and/or may be created by image server 120. In one implementation, database 550 may include a collection of images of similar objects (e.g., popular buildings (e.g., the Eifel tower, the leaning tower of Pisa, Big Ben, etc.), locations (e.g., beaches, palm trees, etc.), etc.) captured at similar locations (e.g., Paris, Pisa, Rome, Miami, etc.), popular images captured by people on vacation, etc. The collection of images provided in database 550 may be received from a publicly shared image community (e.g., Flickr™m) or from stock image databases. A user of user device 110 may subscribe to a service where the user may contribute to the images provided in database 550, as well as benefit from the images provided in database 550.

Distance/history compare logic 555 may include any hardware and/or software based logic that enables image server 120 to compare distance information 170 with picture history 180. In one implementation, distance/history compare logic 555 may receive distance information 170 (e.g., from user device 110) and picture history 180 (e.g., from picture history logic 545), may compare distance information 170 and picture history 180, and may output weighted image information 570. For example, if distance information 170 is received from a high end user device 110, then picture history 180 may be accorded less weight since image 135 received by such a high end user device 110 may be similar or better than the high resolution images contained in image database 550. If distance information 170 is received from a low end user device 110, then picture history 180 may be accorded more weight since image 135 receive by such a low end user device 110 may be lower quality than the high resolution images contained in image database 550. In other implementations, light metering information received by user device 110 may be compared to picture history 180. Distance information 170 (and/or light metering information) may be compared to picture history 180 to locate one or more images that may be approximately the same distance from the object as the image received by user device 110.

Image enhancer logic 560 may include any hardware and/or software based logic that enables image server 120 to generate enhanced image information 190. In one implementation, image enhancer logic 560 may receive weighted image information 570, and may determine enhanced image information 190 based on weighted image information 570. For example, image enhancer logic 560 may replace one or more portions of image 135 that are poor in quality with comparable portions of the high resolution image(s) obtained from image database 550. Image enhancer logic 560 also may eliminate lens flare from image 135, may eliminate unwanted objects (e.g., people, cars, etc.) from image 135, may use quality algorithms to enhance image 135, may use technical measurements of quality (e.g., blur, color balance, etc.) to enhance image 135, etc. Image enhancer logic 560 may create a composite image (e.g., image 135 with enhancements provided by image enhancer logic 560), and may provide the composite image (e.g., via enhanced image information 190) to user device 110. User device 110 may display (e.g., on display 220 or viewfinder) the composite image in real time. Since the functions performed by image enhancer logic 560 may be performed at image server 120, user device 110 need not include expensive image processing logic to produce high quality, high resolution images. In one implementation, image enhance logic 560 may alter basic values (e.g., white balance, color, brightness/contrast, etc.) in real time, may alter values associated with user device (e.g., shutter time, aperture, flash, etc.), and/or may alter the image based on image history.

Although FIG. 5B shows exemplary components of image server 120, in other implementations, image server 120 may contain fewer, different, or additional components than depicted in FIG. 5B. For example, distance/history compare logic 555 may be provided in user device 110 instead of image server 120, and user device 110 may perform the functions described as being performed by distance/history compare logic 555. In still other implementations, one or more components of image server 120 may perform one or more other tasks described as being performed by one or more other components of image server 120.

### Exemplary User Interfaces

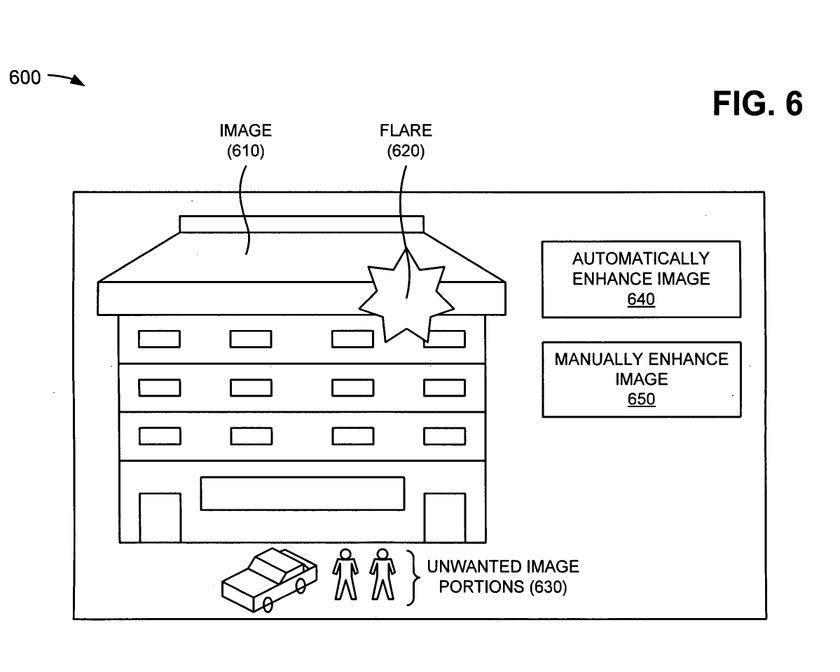

FIGS. 6-9 depict exemplary user interfaces that may be provided by user device 110 (e.g., via user interface 330 and display 220). A user interface 600, as illustrated FIG. 6, may be provided on display 220 of user device 110 if a user aligns an object (e.g., a person, place, or thing) with a viewfinder of user device 110. User interface 600 may include an image 610, flare 620, unwanted image portions 630, an automatically enhance image option 640, and a manually enhance image option 650.

Image 610 may include an image of the object captured by a viewfinder of user device 110. In one implementation, for example, image 610 may include an image of a building. If user device 110 captures image 610, at this time, the captured image may include unwanted flare 620 and/or unwanted image portions 630.

Flare 620 may be created by user device 110 and may produce an unwanted bright spot in image 610. Flare 620 may include light scattered in a lens system of user device 110 through unwanted image formation mechanisms, such as internal reflection and scattering from material inhomogeneities in a lens. Flare 620 may be superimposed across image 610, which may add light to dark regions of image 610 and may reduce contrast of image 610.

Unwanted image portions 630 may include one or more portions of image 610 that a user of user device 110 may wish to omit from the final captured image. In one implementation, for example, unwanted image portions 630 may include images of people, vehicles, etc. User device 110 and/or image server 120 may include object and/or facial recognition algorithms that may be used to eliminate objects or people from an image. User device 110 and/or image server 120 may use such object/facial recognition techniques to compare images and to use portions of images that look similar (e.g., if that is a better match than images found using time or location information).

Automatically enhance image option 640 may include a mechanism (e.g., an icon, a button, a link, etc.) that may be selected by a user of user device 110. If the user selects automatically enhance image option 640, user device 110 may receive the selection, and may provide image 610, measured information (e.g., one or more of location information 140, direction information 150, time information 160, and/or distance information 170), and selection of automatically enhance image option 640 to image server 120. Image server 120 may automatically determine enhanced image information 190 based on the received image 610 and/or the measured information. User device 110 may receive enhanced image information 190 from image server 120, and may display an enhanced image based on enhanced image information 190, as described above in connection with FIGS. 1 and 5B.

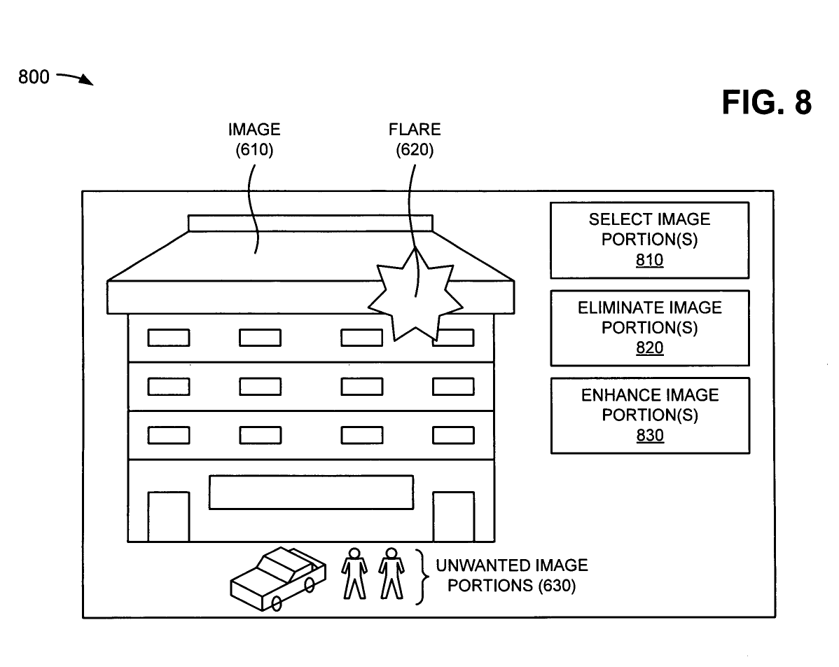

Manually enhance image option 650 may include a mechanism (e.g., an icon, a button, a link, etc.) that may be selected by a user of user device 110. If the user selects manually enhance image option 650, user device 110 may receive the selection, may provide selection of manually enhance image option 650 to image server 120, and may display manual image enhancement suggestions (e.g., via display 220), as described below in connection with FIG. 8.

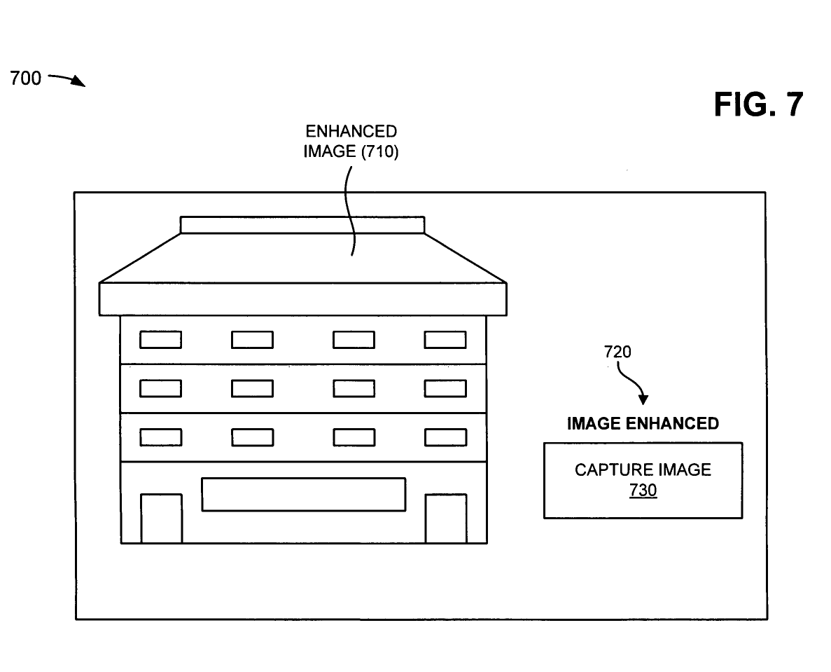

If the user selects automatically enhance image option 640, a user interface 700, as shown in FIG. 7, may be provided on display 220 of user device 110. User device 110 may have received enhanced image information 190 from image server 120, and enhanced image information 190 may have automatically removed flare 620 and unwanted image portions 630 from image 610. Thus, user interface 700 may include an enhanced image 710, an indication 720 that the image is enhanced, and a capture image option 730.

Enhanced image 710 may include a composite image (e.g., image 610 with enhancements provided by image enhancer logic 560) calculated by image server 120. Image server 120 may provide enhanced image 710 (e.g., via enhanced image information 190) to user device 110. User device 110 may receive enhanced image information 190 from image server 120, may display enhanced image 710 based on enhanced image information 190, and may permit a user to capture and/or store enhanced image 710. Alternatively and/or additionally, user device 110 may provide enhanced image 710 to image server 120, and image server 120 may store enhanced image 710 (e.g., in image database 550).

Indication 720 may provide a visual indication (e.g., textual, graphical, textual/graphical, etc.) that image 610 has been enhanced (e.g., as enhanced image 710). For example, as shown in FIG. 7, indication 720 may state “IMAGE ENHANCED.” This may provide an indication that enhanced image 710 is ready to be captured by user device 110.

Capture image option 730 may include a mechanism (e.g., an icon, a button, a link, etc.) that may be selected by a user of user device 110. If the user selects capture image option 730, user device 110 may capture enhanced image 710 and/or may store the captured enhanced image 710 (e.g., in memory 320). The captured enhanced image 710 may not include flare 620 and/or unwanted image portions 630.

If the user selects manually enhance image option 650, a user interface 800, as shown in FIG. 8, may be provided on display 220 of user device 110. As illustrated, user interface 800 may include manual image enhancement suggestions, such as a select image portion(s) suggestion 810, an eliminate image portion(s) suggestion 820, and an enhance image portion(s) suggestion 830.

Select image portion(s) suggestion 810 may provide a visual suggestion (e.g., textual, graphical, textual/graphical, etc.) to the user to select one or more portions of image 610. For example, the user of user device 110 may select (e.g., draw a box around, point to, highlight, etc.) flare 620 and some of unwanted image portions 630 (e.g., a vehicle and a single person). The user may then select one or more of suggestions 820 and 830, and user device 110 may provide the user's selections (e.g. user input 565), image 610, and measured information (e.g., one or more of location information 140, direction information 150, time information 160, and/or distance information 170) to image server 120. Image server 120 may determine enhanced image information 190 based on the received user input 565, image 610, and/or the measured information. User device 110 may receive enhanced image information 190 from image server 120, and may display an enhanced image based on enhanced image information 190, as described above in connection with FIGS. 1 and 5B.

Eliminate image portion(s) suggestion 820 may provide a visual suggestion (e.g., textual, graphical, textual/graphical, etc.) to the user to eliminate the image portion(s) selected by the user via select image portion(s) suggestion 810 (e.g., flare 620 and some of unwanted image portions 630).

Enhance image portion(s) suggestion 830 may provide a visual suggestion (e.g., textual, graphical, textual/graphical, etc.) to the user to enhance the image portion(s) selected by the user via select image portion(s) suggestion 810 (e.g., flare 620 and some of unwanted image portions 630). For example, selection of enhance image portion(s) suggestion 820 may cause image server 120 (e.g., via user device 110) to enhance (e.g., correct lens flare, improve image resolution, color, and/or lighting, remove image blur, etc.) the selected image portion(s).

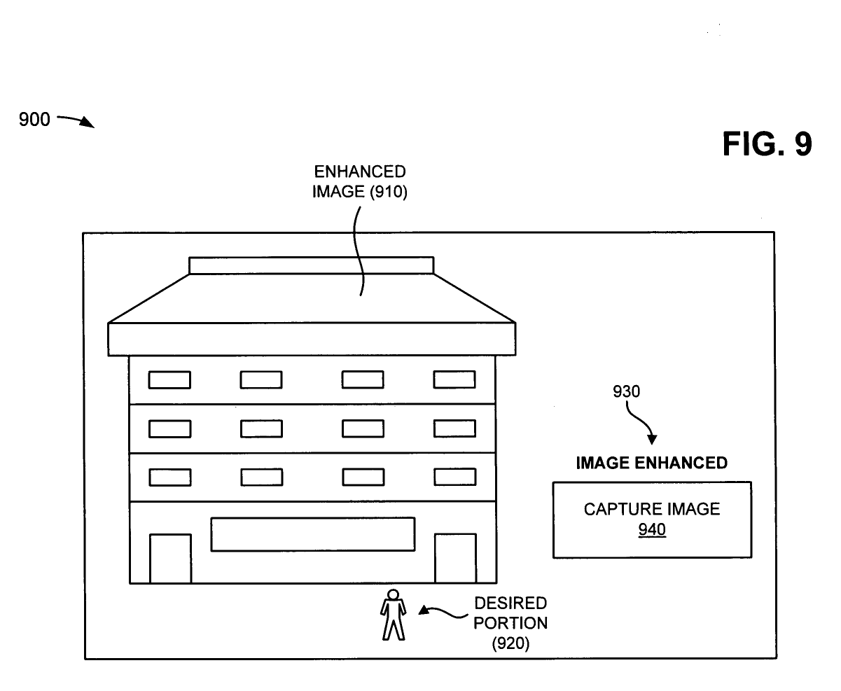

If the user selects one or more of select image portion(s) suggestion 810, eliminate image portion(s) suggestion 820, and enhance image portion(s) suggestion 830, a user interface 900, as shown in FIG. 9, may be provided on display 220 of user device 110. User device 110 may have received enhanced image information 190 from image server 120, and enhanced image information 190 may have removed flare 620 and some of unwanted image portions 630 from image 610. Thus, user interface 900 may include an enhanced image 910, a desired portion 920, an indication 930 that the image is enhanced, and a capture image option 940.

Enhanced image 910 may include a composite image (e.g., image 610 with enhancements provided by image enhancer logic 560) calculated by image server 120. Image server 120 may provide enhanced image 910 (e.g., via enhanced image information 190) to user device 110. User device 110 may receive enhanced image information 190 from image server 120, may display enhanced image 910 based on enhanced image information 190, and may permit a user to capture and/or store enhanced image 910. Alternatively and/or additionally, user device 110 may provide enhanced image 910 to image server 120, and image server 120 may store enhanced image 910 (e.g., in image database 550).

Desired portion 920 may include a portion of unwanted image portions 630 that the user decided to keep with enhanced image 910 (e.g., the user selected portions of unwanted image portions 630 to eliminate). In this example, desired portion 920 may include an image of a person to be included with enhanced image 910.

Indication 930 may provide a visual indication (e.g., textual, graphical, textual/graphical, etc.) that image 610 has been enhanced (e.g., as enhanced image 910). For example, as shown in FIG. 9, indication 930 may state “IMAGE ENHANCED.” This may provide an indication that enhanced image 910 is ready to be captured by user device 110.

Capture image option 940 may include a mechanism (e.g., an icon, a button, a link, etc.) that may be selected by a user of user device 110. If the user selects capture image option 940, user device 110 may capture enhanced image 910 and/or may store the captured enhanced image 910 (e.g., in memory 320). The captured enhanced image 910 may not include flare 620 and/or some of unwanted image portions 630.

In an alternative implementation, user device 110 may not display automatically enhance image option 640 and manually enhance image option 650, but may automatically provide image 135 and measured information (e.g., one or more of location information 140, direction information 150, time information 160, and/or distance information 170) to image server 120. Image server 120 may automatically determine enhanced image information 190 based on the received image 135 and/or the measured information. User device 110 may receive enhanced image information 190 from image server 120, and may display an enhanced image based on enhanced image information 190. Such an automatic arrangement may be enabled or disabled by a user of user device 110.

Although FIGS. 6-9 show exemplary elements of user interfaces 600-900, respectively, in other implementations, each of user interfaces 600-90 may contain fewer, different, or additional elements than depicted in FIGS. 6-9.

### Exemplary Processes

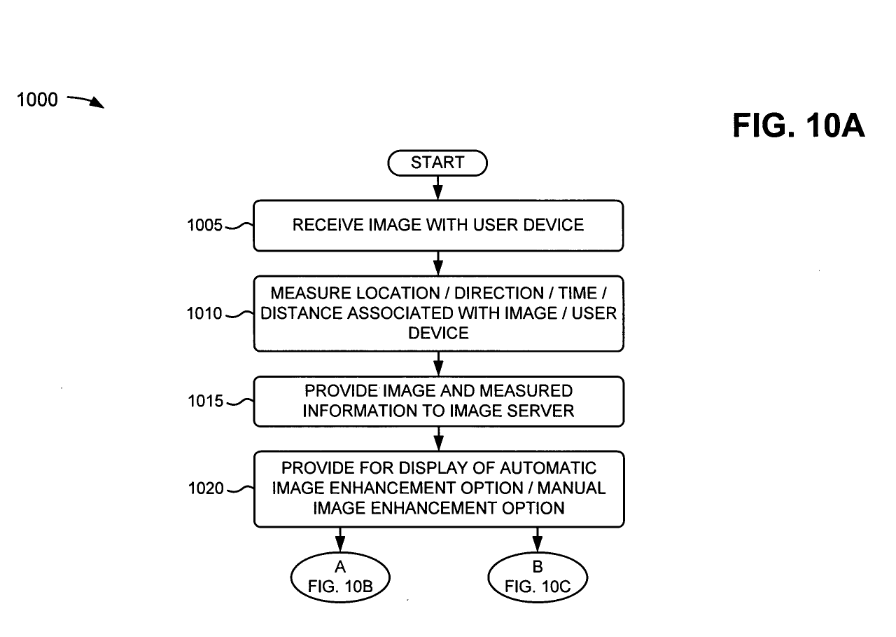

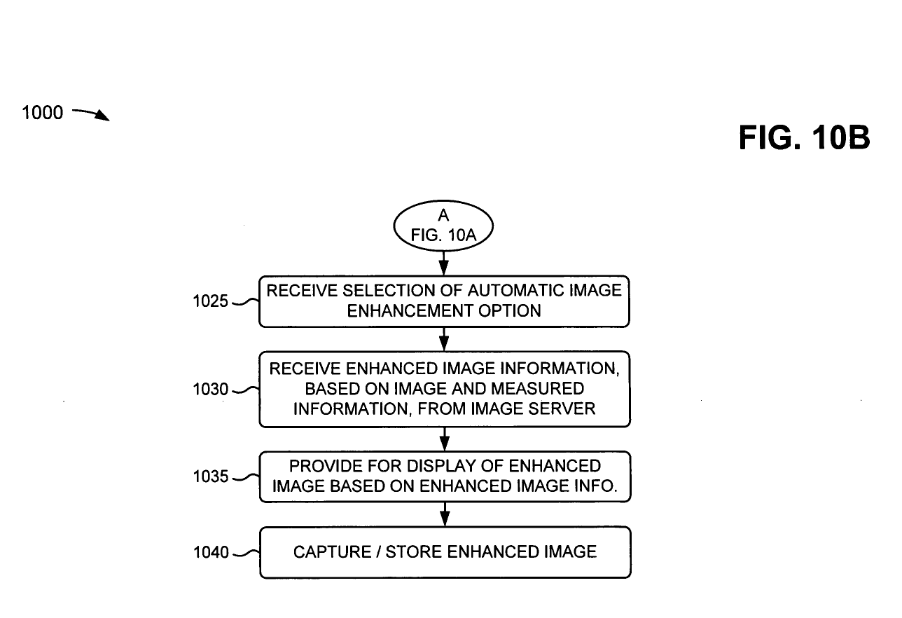

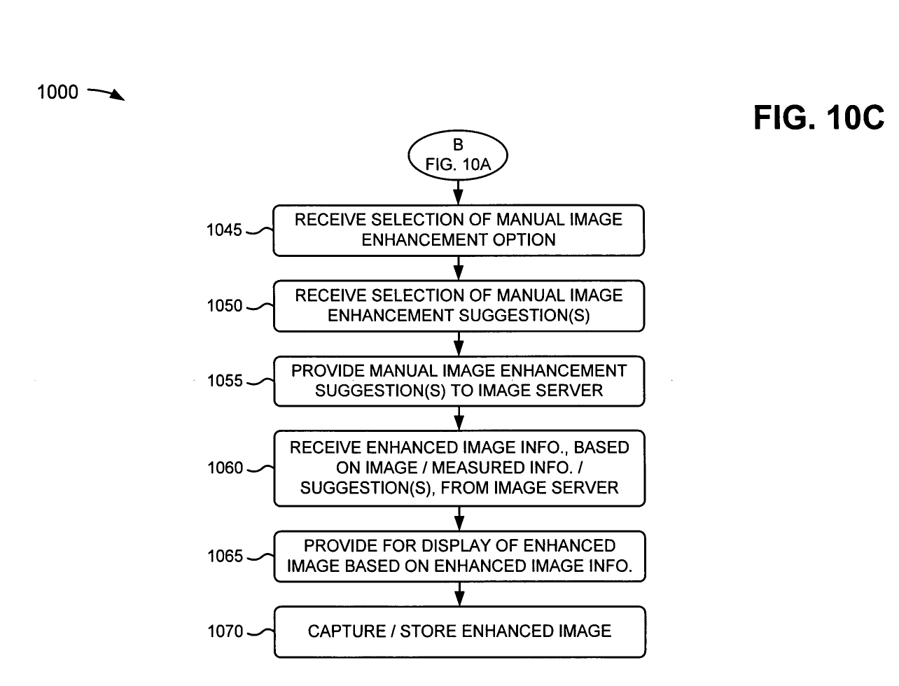

FIGS. 10A-10C depict flow charts of an exemplary process 1000 for intelligently enhancing an image according to implementations described herein. In one implementation, process 1000 may be performed by hardware and/or software components of user device 110 (e.g., processing logic 310). In other implementations, process 1000 may be performed by hardware and/or software components of user device 110 (e.g., processing logic 310) in combination with hardware and/or software components of another device (e.g., communicating with user device 110 via communication interface 340).

As illustrated in FIG. 10A, process 1000 may begin with receipt of an image with a user device (block 1005), and a measurement of information (e.g., a location, a direction, a time, and/or a distance) associated with the user device and/or the received image (block 1010). For example, in one implementation described above in connection with FIG. 1, user device 110 may receive image 135, and may determine location information 140, direction information 150, time information 160, and/or distance information 170. Image 135 may include an image (e.g., displayed on a display screen/viewfinder of user device 110) of any object (e.g., person, place, or thing). Location information 140 may include positional (e.g., latitude, longitude, etc.) information associated with user device 110 and/or the object included in image 135. Direction information 150 may include orientation (e.g., tilted, turned, pointing to the north, south, east, west, etc.) information associated with user device 110. Time information 160 may include a time (e.g., day time, night time, a specific time of day, etc.) when image 135 is received by user device 110. Distance information 170 may include a distance (e.g., in feet, meters, etc.) that an object represented by image 135 is separated from user device 110.

Returning to FIG. 10A, the image and the measured information may be provided to an image server (block 1015). For example, in one implementation described above in connection with FIG. 1, user device 110 may provide image 135, location information 140, direction information 150, time information 160, and/or distance information 170 to image server 120.

As further shown in FIG. 10A, an automatic image enhancement option and a manual image enhancement option may be provided for display (block 1020). For example, in one implementation described above in connection with FIG. 6, user interface 600 of user device 110 may display automatically enhance image option 640 and manually enhance image option 650. Automatically enhance image option 640 may include a mechanism (e.g., an icon, a button, a link, etc.) that may be selected by a user of user device 110. Manually enhance image option 650 may include a mechanism (e.g., an icon, a button, a link, etc.) that may be selected by a user of user device 110. In other implementations, user device 110 may provide the user a single option (i.e., automatically enhance image option 640 or manually enhance image option 650).

If a user of user device 110 selects the displayed automatic image enhancement option (block 1020), the process blocks depicted in FIG. 10B may be implemented. As illustrated, a selection of the automatic image enhancement option may be received (block 1025), and enhanced image information, based on the image and the measured information, may be received from the image server (block 1030). For example, in one implementation described above in connection with FIG. 6, if the user selects automatically enhance image option 640, user device 110 may receive the selection, and may provide image 610 and measured information (e.g., one or more of location information 140, direction information 150, time information 160, and/or distance information 170 (including light metering information)) to image server 120. Image server 120 may automatically determine enhanced image information 190 based on the received image 610 and/or the measured information. User device 110 may receive enhanced image information 190 from image server 120.

Returning to FIG. 10B, an enhanced image based on the enhanced image information may be provided for display (block 1035), and the enhanced image may be captured and/or stored (block 1040). For example, in one implementation described above in connection with FIGS. 6 and 7, user interface 700 may be provided on display 220 of user device 110 and may include enhanced image 710 and capture image option 730. Capture image option 730 may include a mechanism (e.g., an icon, a button, a link, etc.) that may be selected by a user of user device 110. If the user selects capture image option 730, user device 110 may capture enhanced image 710 and/or may store the captured enhanced image 710 (e.g., in memory 320). Alternatively, user device 110 may capture the image automatically in response to the selecting automatically enhance image option 640. In either event, the captured enhanced image 710 may not include flare 620 and/or unwanted image portions 630.

If a user of user device 110 selects the displayed manual image enhancement option (block 1020), the process blocks in FIG. 10C may be implemented. As illustrated, a selection of the manual image enhancement option may be received (block 1045), a selection of one or more manual image enhancement suggestions may be received (block 1050), and one or more of the selected manual image enhance suggestions may be provided to the image server (block 1055). For example, in one implementation described above in connection with FIGS. 6 and 8, if the user selects manually enhance image option 650, user device 110 may receive the selection, and may display manual image enhancement suggestions (e.g., via user interface 800 on display 220). User interface 800 may include manual image enhancement suggestions, such as select image portion(s) suggestion 810, eliminate image portion(s) suggestion 820, and enhance image portion(s) suggestion 830. Select image portion(s) suggestion 810 may provide a visual suggestion (e.g., textual, graphical, textual/graphical, etc.) to the user to select one or more portions of image 610. Eliminate image portion(s) suggestion 820 may provide a visual suggestion (e.g., textual, graphical, textual/graphical, etc.) to the user to eliminate the image portion(s) selected by the user (e.g., flare 620 and some of unwanted image portions 630). Enhance image portion(s) suggestion 830 may provide a visual suggestion (e.g., textual, graphical, textual/graphical, etc.) to the user to enhance the image portion(s) selected by the user (e.g., flare 620 and some of unwanted image portions 630). User device 110 may provide the selected manual image enhancement suggestions (e.g., suggestions 810-830) to image server 120.

Returning to FIG. 10C, enhanced image information, based on the image, the measured information and the manual image enhancement suggestions, may be received from the image server (block 1060), an enhanced image based on the enhanced image information may be provided for display (block 1065), and the enhanced image may be captured and/or stored (block 1070). For example, in one implementation described above in connection with FIGS. 8 and 9, if the user selects one or more of select image portion(s) suggestion 810, eliminate image portion(s) suggestion 820, and enhance image portion(s) suggestion 830, user interface 900 may be provided on display 220 of user device 110. User device 110 may have received enhanced image information 190 from image server 120, and enhanced image information 190 may have removed flare 620 and some of unwanted image portions 630 from image 610. User interface 900 may include enhanced image 910 and capture image option 940. Capture image option 940 may include a mechanism (e.g., an icon, a button, a link, etc.) that may be selected by a user of user device 110. If the user selects capture image option 940, user device 110 may capture enhanced image 910 and/or may store the captured enhanced image 910 (e.g., in memory 320). The captured enhanced image 910 may not include flare 620 and/or some of unwanted image portions 630. In one example, enhanced image 910 may contain portions of an image that matches with the measured information (e.g., one or more of location information 140, direction information 150, time information 160, and/or distance information 170 (including light metering information)) provided by user device 110 to image server 120. The portions of the matching image may be extracted from one or more images stored in image database 550.

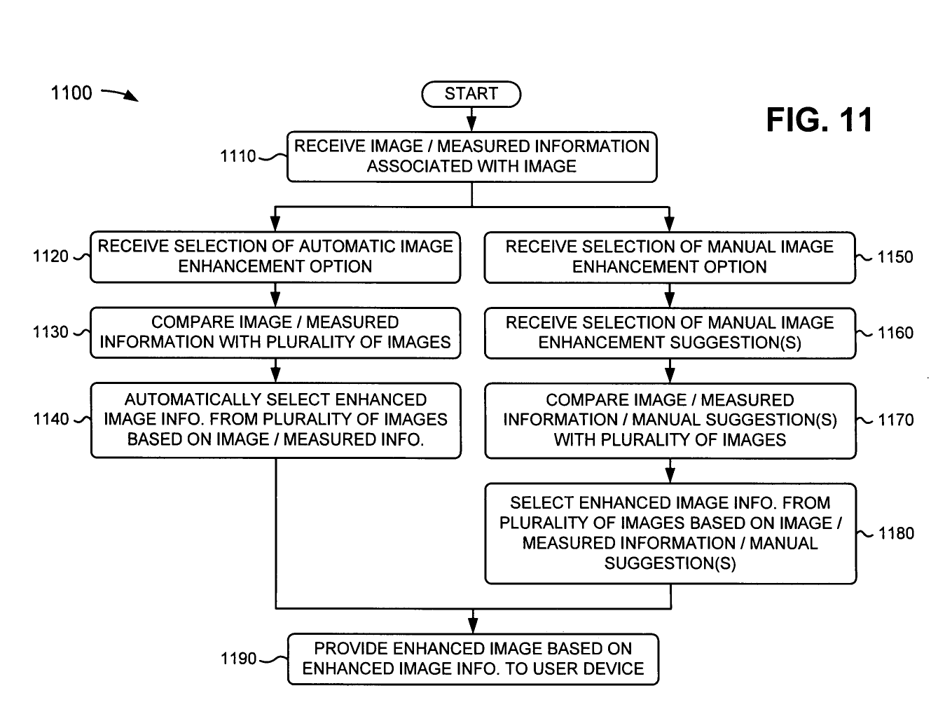

FIGS. 11-13 depict flow charts of an exemplary process 1100 for intelligently enhancing an image according to implementations described herein. In one implementation, process 1100 may be performed by hardware and/or software components of image server 120 (e.g., processing logic 5 10). In other implementations, process 1100 may be performed by hardware and/or software components of image server 120 (e.g., processing logic 510) in combination with hardware and/or software components of another device (e.g., communicating with image server 120 via communication interface 540).

As illustrated in FIG. 11, process 1100 may begin with receipt of an image and measured information associated with the image (block 1110), and one of receipt of a selection of an automatic image enhancement option (block 1120) or receipt of a selection of a manual image enhancement option (block 1150). For example, in one implementation described above in connection with FIGS. 1 and 6, image server 120 may receive image 135, location information 140, direction information 150, time information 160, and/or distance information 170. If the user selects automatically enhance image option 640, user device 110 may receive the selection, and may provide selection of automatically enhance image option 640 to image server 120. If the user selects manually enhance image option 650, user device 110 may receive the selection, may provide selection of manually enhance image option 650 to image server 120.

As further shown in FIG. 11, if the user selects automatically enhance image option 640 (block 1120), the image and the measured information may be compared with a plurality of images (block 1130), and enhanced image information may be automatically selected from the plurality of images based on the image and the measured information (block 1140). For example, in one implementation described above in connection with FIG. 5B, picture history logic 545 of image server 120 may receive image 135, location information 140, direction information 150, and/or time information 160 from user device 110, and may compare image 135 with one or more images provided in image database 550 based on the received information. Picture history logic 545 may output any images of image database 550 matching the location, direction, and time criteria as picture history 180 (e.g., to distance/history compare logic 555). Distance/history compare logic 555 may receive distance information 170 (e.g., from user device 110) and picture history 180 (e.g., from picture history logic 545), may compare distance information 170 and picture history 180, and may output weighted image information 570. Image enhancer logic 560 may receive weighted image information 570, and may automatically determine enhanced image information 190 based on weighted image information 570.

Returning to FIG. 11, if the user selects manually enhance image option 650 (block 1150), a selection of one or more manual image enhancement suggestions may be received (block 1160), the image, the measured information, and the selected one or more manual image enhancement suggestions may be compared with a plurality of images (block 1170), and enhanced image information may be selected from the plurality of images based on the image, the measured information, and the one or more manual image enhancement suggestions (block 1180). For example, in one implementation described above in connection with FIG. 5B, picture history logic 545 of image server 120 may receive image 135, location information 140, direction information 150, time information 160, and/or user input 565 (e.g., manual image enhancement user inputs) from user device 110, and may compare image 135 with one or more images provided in image database 550 based on the received information. Picture history logic 545 may output any images of image database 550 matching the location, direction, time, and user input criteria as picture history 180 (e.g., to distance/history compare logic 555). Distance/history compare logic 555 may receive distance information 170 (e.g., from user device 110) and picture history 180 (e.g., from picture history logic 545), may compare distance information 170 and picture history 180, and may output weighted image information 570. Image enhancer logic 560 may receive weighted image information 570, and may determine enhanced image information 190 based on weighted image information 570.

As further shown in FIG. 11, an enhanced image based on the enhanced image information may be provided to a user device (block 1190). For example, in one implementation described above in connection with FIG. 5B, image enhancer logic 560 of image server 120 may create an enhanced composite image (e.g., image 135 with enhancements provided by image enhancer logic 560), and may provide the enhanced composite image (e.g., via enhanced image information 190) to user device 110. User device 110 may display (e.g., on display 220 or viewfinder) the composite image in real time or near real time. Examples of enhanced composite may include enhanced image 710 (FIG. 7) and/or enhanced image 910 (FIG. 9).

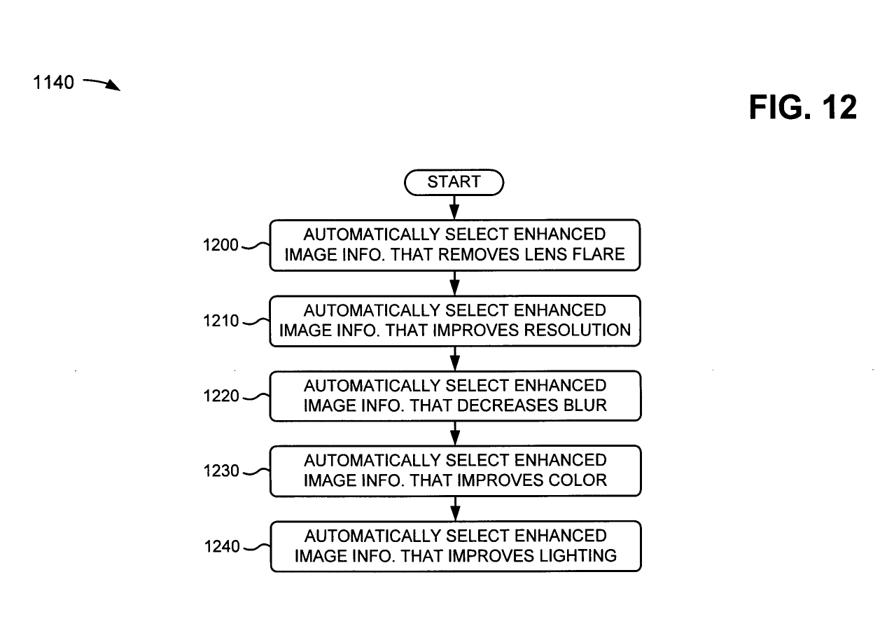

Process block 1140 may include the process blocks depicted in FIG. 12. As illustrated, process block 1140 may include one or more of automatically selecting enhanced image information that removes lens flare (block 1200), automatically selecting enhanced image information that improves image resolution (block 1210), automatically selecting enhanced image information that decreases image blur (block 1220), automatically selecting enhanced image information that improves image color (block 1230), and/or automatically selecting enhanced image information that improves image lighting (block 1240). For example, in one implementation described above in connection with FIG. 5B, image enhancer logic 560 of image server 120 may replace one or more portions of image 135 that are poor in quality with comparable portions of the high resolution image(s) obtained from image database 550. Image enhancer logic 560 also may eliminate lens flare from image 135, may eliminate unwanted objects (e.g., people, cars, etc.) from image 135, may use quality algorithms to enhance image 135, may use technical measurements of quality (e.g., blur, color balance, etc.) to enhance image 135, etc.

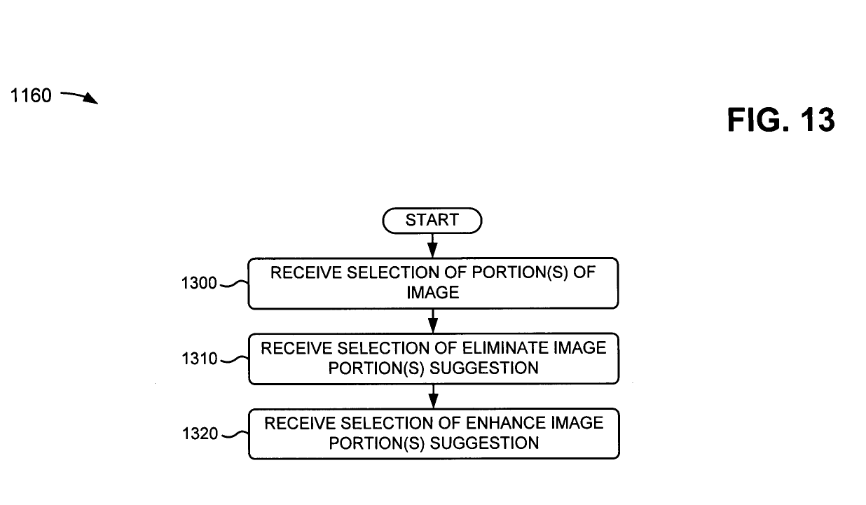

Process block 1160 may include the process blocks depicted in FIG. 13. As illustrated, process block 1160 may include receiving selection of one or more portions of the image (block 1300), receiving selection of eliminate image portion(s) suggestion (block 1310), and/or receiving selection of enhance image portion(s) suggestion (block 1320). For example, in one implementation described above in connection with FIG. 8, select image portion(s) suggestion 810 may provide a visual suggestion (e.g., textual, graphical, textual/graphical, etc.) to the user to select one or more portions of image 610. The user may then select one or more of suggestions 820 and 830, and user device 110 may provide the user's selections (e.g. user input 565) to image server 120. Eliminate image portion(s) suggestion 820 may provide a visual suggestion (e.g., textual, graphical, textual/graphical, etc.) to the user to eliminate the image portion(s) selected by the user (e.g., flare 620 and some of unwanted image portions 630). Enhance image portion(s) suggestion 830 may provide a visual suggestion (e.g., textual, graphical, textual/graphical, etc.) to the user to enhance the image portion(s) selected by the user (e.g., flare 620 and some of unwanted image portions 630). For example, image server 120 may replace the selected portions of image 135 with higher resolution portions of the images stored in image database 550.

### Conclusion

Implementations described herein may provide systems and methods that intelligently enhance images captured by a user device in real time or near real time. For example, in one implementation, a user device may receive an image and/or measured information associated with the user device and/or received image (e.g., one or more of location information, direction information, time information, and/or distance information), and may provide the received image and/or the measured information to an image server. The image server may compare the received image and the measured information with a plurality of images, and may intelligently select enhanced image information based on the received image and/or the measured information. The user device may receive the enhanced image information from the image server, may provide for display of an enhanced image based on the enhanced image information, and may permit a user to capture and/or store the enhanced image.

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 10A-13, the order of the blocks may be modified in other implementations. Further, non-dependent blocks may be performed in parallel.

Also, the term “user” has been used herein, and is intended to be broadly interpreted to include user device 110 or a user of user device 110.

It should be emphasized that the term “comprises/comprising” when used in the this specification is taken to specify the presence of stated features, integers, steps or components but does not preclude the presence or addition of one or more other features, integers, steps, components or groups thereof.

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code--it being understood that software and control hardware could be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving an image with a user device;
measuring at least one of location information, direction information, time information, or distance information associated with the user device;
providing the image and the at least one of location information, direction information, time information, or distance information to an image server;
receiving, from the image server, enhanced image information based on the image and the at least one of location information, direction information, time information, or distance information;
capturing an enhanced image based on the enhanced image information; and
storing the enhanced image.

2. The method of claim 1, further comprising:
providing for display an automatic image enhancement option; and
receiving selection of the automatic image enhancement option.

3. The method of claim 1, further comprising:
providing for display a manual image enhancement option;
receiving selection of the manual image enhancement option;
providing for display one or more manual image enhancement suggestions;
receiving selection of the one or more manual image enhancement suggestions; and
receiving, from the image server, the enhanced image information based on the image, the at least one of location information, direction information, time information, or distance information, and selected one or more manual image enhancement suggestions.

4. The method of claim 3, where providing for display the one or more manual image enhancement suggestions comprises:
providing for display a suggestion to select a portion of the image;
providing for display a suggestion to eliminate the selected image portion; and
providing for display a suggestion to enhance the selected image portion.

5. The method of claim 1, further comprising:
providing the enhanced image to the image server for storage.

6. A method, comprising:
receiving an image from a user device;
receiving measured information that includes one or more of location information, direction information, time information, or distance information associated with the user device;
comparing the image and the measured information with a plurality of images;
selecting enhanced image information from the plurality of images based on the image and the measured information;
creating an enhanced image based on the enhanced image information; and
providing the enhanced image to the user device.

7. The method of claim 6, further comprising:
receiving selection of an automatic image enhancement option.

8. The method of claim 6, further comprising:
receiving selection of a manual image enhancement option.

9. The method of claim 8, further comprising:
receiving selection of one or more manual image enhancement suggestions;
comparing the image, the measured information, and the selected one or more manual image enhancement suggestions with the plurality of images; and
selecting the enhanced image information from the plurality of images based on the image, the measured information, and the selected one or more manual image enhancement suggestions.

10. The method of claim 9, where receiving selection of one or more manual image enhancement suggestions comprises at least one of:
receiving selection of a portion of the image;
receiving selection to eliminate the selected image portion; or receiving selection to enhance the selected image portion.

11. The method of claim 6, where selecting enhanced image information comprises at least one of:
automatically selecting enhanced image information that removes lens flare from the image;
automatically selecting enhanced image information that improves resolution of the image;
automatically selecting enhanced image information that decreases blur in the image;
automatically selecting enhanced image information that improves a color balance of the image; or automatically selecting enhanced image information that improves lighting of the image.

12. A user device, comprising:
an image receiving device that receives an image;
a monitoring device that measures at least one of location information, direction information, time information, or distance information associated with the image or the user device; and
processing logic configured to:
provide the image and the at least one of location information, direction information, time information, or distance information to an image server,
receive, from the image server, enhanced image information based on the image and the at least one of location information, direction information, time information, or distance information,
capture an enhanced image based on the enhanced image information, and
store the enhanced image.

13. The user device of claim 12, where the monitoring device comprises at least one of:
a global positioning system (GPS) receiver;
an accelerometer;
a gyroscope;
a compass;
a GPS-based clock;
a proximity sensor;
a laser distance sensor;
a distance sensor using echo location with high frequency sound waves; or
an infrared distance sensor;

14. The user device of claim 12, where the enhanced image comprises a composite image that includes one or more original portions of the image and one or more portions of the image that have been replaced, enhanced, or corrected based on the enhanced image information.

15. The user device of claim 12, where the processing logic is further configured to:
provide for display an automatic image enhancement option; and
receive selection of the automatic image enhancement option.

16. The user device of claim 12, where the processing logic is further configured to:
provide for display a manual image enhancement option;
receive selection of the manual image enhancement option;
provide for display one or more manual image enhancement suggestions;
receive selection of the one or more manual image enhancement suggestions; and
receive, from the image server, the enhanced image information based on the image, the at least one of location information, direction information, time information, and distance information, or the selected one or more manual image enhancement suggestions.

17. The user device of claim 16, where the processing logic is further configured to:
provide for display a suggestion to select a portion of the image;
provide for display a suggestion to eliminate the selected image portion; and
provide for display a suggestion to enhance the selected image portion.

18. The user device of claim 12, where the processing logic is further configured to:
provide the enhanced image to the image server for storage.

19. The user device of claim 12, where the user device comprises at least one of:
a mobile communication device;
a laptop;
a personal computer;
a camera;
a video camera;
binoculars with a camera; or
a telescope with a camera.

20. A system, comprising:
one or more devices configured to:
receive an image from a user device,
receive measured information that includes one or more of location information, direction information, time information, or distance information associated with the image or the user device,
receive selection of an automatic image enhancement option or a manual image enhancement option,
automatically compare the image and the measured information with a plurality of images when the automatic image enhancement option is selected,
automatically select enhanced image information from the plurality of images based on the image and the measured information when the automatic image enhancement option is selected,
receive selection of one or more manual image enhancement suggestions when the manual image enhancement option is selected,
compare the image, the measured information, and the selected one or more manual image enhancement suggestions with the plurality of images when the manual image enhancement option is selected,
select the enhanced image information from the plurality of images based on the image, the measured information, and the selected one or more manual image enhancement suggestions when the manual image enhancement option is selected,
create an enhanced image based on the enhanced image information, and
provide the enhanced image to the user device for display.

21. A system, comprising:
means for receiving an image from a user device;
means for receiving measured information that includes one or more of location information, direction information, time information, or distance information associated with the user device;
means for comparing the image and the measured information with a plurality of images;
means for selecting enhanced image information from the plurality of images based on the image and the measured information;
means for creating an enhanced image based on the enhanced image information; and
means for providing the enhanced image to the user device for display.
